(19) United States
(12) Patent Application Publication
(10) Pub. No.: US 2010/0103380 A1
(43) Pub. Date: Apr. 29, 2010

(54) CRITICAL ABBE ILLUMINATION CONFIGURATION

(75) Inventor: Patrick Rene Destain, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/257,025

(22) Filed: Oct. 23, 2008

(51) Int. Cl. G03B 21/28; F21V 7/00

(52) U.S. Cl. 353/37; 362/308

(57) ABSTRACT

The present invention relates to an optical projection illumination module that projects highly uniform radiative energy (e.g., visible light, ultraviolet radiation, infrared radiation, etc.) onto a target area. More particularly, the illumination module comprises a radiative energy source (e.g., a LED) configured to provide divergent radiative energy (e.g., a non-uniform illumination) directly to a reflective tunnel (e.g., a total internal reflection tunnel), separated from the radiative energy source by a small gap and optically in contact (e.g., physically coupled) to a front optical element (e.g., collimator lens). The reflective tunnel mixes the divergent radiative energy, and outputs a substantially uniform radiative energy to a front optical element. One or more downstream optical elements image the output of the reflective tunnel directly to the target area (i.e., the object imaged on to the target area is located on an image plane embedded between the reflective tunnel and the front optical element).

### FIELD OF INVENTION

The present invention relates generally to an illumination module and more particularly to an optical projection system that provides a substantially uniform illumination over a projected area.

### BACKGROUND OF THE INVENTION

Illumination modules have a wide range of applications in a variety of fields, including projection displays, sun simulators, backlights for liquid crystal displays (LCDs), and others. Projection systems usually include a source of radiative energy, illumination optics, an image-forming device, projection optics, and a projection screen. The illumination optics collect light from a light source and direct it to one or more image-forming devices in a predetermined manner. The image-forming device(s), controlled by an electronically conditioned and processed digital video signal, produces an image corresponding to the video signal. Projection optics then magnify the image and project it onto the projection screen.

Modern projector systems predominately utilize light emitting diodes (LEDs) as an illumination source. Light emitting diodes are semiconductor devices (e.g., semiconducting p-n diodes) that emit radiative energy when an electrical current is applied to the device. The emitted radiative energy is incoherent and has a wavelength corresponding to the band gap of the semiconductor device used to form the LED. Accordingly, the emitted radiative energy is a narrow-spectrum light emitted from the p-n junction.

LEDs offer a number of advantages over other illumination sources (e.g., white light sources such as arc lamps) including longer lifetime, higher efficiency, and superior thermal characteristics.

One example of an image-forming device frequently used in digital light processing systems is a digital micro-mirror device (DMD). The main feature of a DMD is an array of rotatable micro-mirrors. The tilt of each mirror is independently controlled by the data loaded into a memory cell associated with each mirror, to steer reflected light and spatially map a pixel of video data to a pixel on a projection screen. Light reflected by a mirror in an “on” state passes through the projection optics and is projected onto the projection screen to create a bright field (e.g., pixel). Alternatively, light reflected by a mirror in an “off” state misses the projection optics, resulting in a dark field (e.g., pixel). A color image also may be produced using a DMD by utilizing color sequencing, or, alternatively, using three DMDs, one for each primary color.

Other examples of image-forming devices include liquid crystal panels, such as a liquid crystal on silicon device (LCOS), which are typically rectangular. In liquid crystal panels, the alignment of the liquid crystal material is controlled incrementally (pixel-to-pixel) according to the data corresponding to a video signal. Depending on the alignment of the liquid crystal material, polarization of the incident light may be altered by the liquid crystal structure. Thus, with appropriate use of polarizers or polarizing beam splitters, dark and light regions may be created, which correspond to the input video data. Color images have been formed using liquid crystal panels in the manner similar to the DMDs.

### SUMMARY OF THE INVENTION

The following presents a simplified summary in order to provide a basic understanding of one or more aspects of the invention. This summary presents one or more concepts of the invention in a simplified form as a prelude to the more detailed description that is presented later and is not an extensive overview of the invention. In this regard, the summary is not intended to identify key or critical elements of the invention, nor does the summary delineate the scope of the invention.

The present invention relates to an optical projection illumination module that projects highly uniform radiative energy (e.g., visible light, ultraviolet radiation, infrared radiation, etc.) onto a target area. More particularly, the illumination module comprises a radiative energy source (e.g., a LED) configured to provide divergent radiative energy (e.g., a non-uniform illumination) directly to a reflective tunnel (e.g., Total Internal Reflection (TIR) tunnel), separated from the radiative energy source by a small gap and optically in contact (e.g., physically coupled) to a front optical element (e.g., collimator lens). The reflective tunnel mixes the divergent radiative energy, and outputs a substantially uniform radiative energy to a front optical element. One or more downstream optical elements image the output of the reflective tunnel directly to the target area (e.g., the object imaged on to the target area is located on an image plane embedded between the reflective tunnel and the front optical element).

The following description and annexed drawings set forth in detail certain illustrative aspects and implementations of the invention. These are indicative of but a few of the various ways in which the principles of the invention may be employed.

### BRIEF DESCRIPTION OF THE DRAWINGS

FIG. 1 illustrates a block diagram of a first embodiment of an illumination module according to the present invention;

FIG. 2 illustrates a block diagram of a light engine configured to directly image an illumination source onto a SLM having a matching aspect ratio;

FIGS. 3A-3C illustrate schematic diagrams of an illumination source and TIR tunnel according to the present invention;

FIG. 4 illustrates a ray diagram of a more detailed embodiment of a light engine comprising an illumination module according to the present invention;

FIGS. 5A-5E illustrate the effect that an illumination source's divergence has on the output of a TIR tunnel for a variety of angles;

FIG. 6 shows a ray diagram illustrating the effect of having a TIR tunnel and a front lens configured to have different indices of refraction;

FIG. 7 illustrates a more detailed example of an illumination module as provided herein;

FIG. 8 illustrates a graph showing the coupling efficiency of an LED illumination source and TIR tunnel vs. gap size between the LED and reflective tunnel;

FIG. 9 illustrates an exemplary embodiment of a light engine that utilizes Abbe critical illumination to directly image the illumination module provided herein onto an associated DMD;

FIG. 10 illustrates a block diagram of a projector and light engine comprising a plurality of illumination sources;

FIG. 11 illustrates a method for generating an optical system that uniformly images an illumination source onto a spatial light modulator (SLM); and

FIG. 12 is a schematic representation of a wall-mounted projection system utilizing the exemplary optical system.

### DETAILED DESCRIPTION OF THE INVENTION

The present invention will now be described with reference to the attached drawing figures, wherein like reference numerals are used to refer to like elements throughout, and wherein the illustrated structures and devices are not necessarily drawn to scale.

For digital projectors to produce high quality projected images it is desirable to display a uniform (i.e., homogeneous) illumination over the area of the projected image. Often it is difficult to project illumination sources in a uniform manner, because the illumination sources have non-uniform emitting areas that do not provide a uniform emission profile. For example, a light emitting diode (LED), which is commonly used as a projector illumination source, may have wiring bonding connections which, when projected, are visible with a high contrast or may exhibit current density non-uniformity providing different emission profiles between the center of the LED and the corners. To compensate for the lack of uniformity in illumination sources, optical engines comprised within the digital projectors will often utilize special techniques to achieve uniform illumination over the area of a projected image. For example, a fly eyes array (i.e., a two dimensional array comprising individual optical elements assembled into a single optical element) may be placed between the illumination source and a projection area to improve the uniformity of projected irradiance onto a projection screen. However, such conventional techniques add size and complexity to an optical projection illumination module design. Therefore, there is a need for an optical projection illumination module which provides a uniform illumination without increasing the size or complexity of the module.

The present invention relates to an optical projection illumination module that projects highly uniform radiative energy (e.g., visible light, ultraviolet radiation, infrared radiation, etc.) onto a target area (e.g., a SLM, DMD). More particularly, the illumination module comprises a radiative energy source (e.g., a LED) configured to provide divergent radiative energy (e.g., a non-uniform illumination) directly to a reflective tunnel (e.g., total internal reflection tunnel (TIR) tunnel), separated from the radiative energy source by a small gap and optically in contact (e.g., physically coupled) to a front optical element (e.g., collimator lens). The reflective tunnel mixes the divergent radiative energy, and outputs a substantially uniform radiative energy to a front optical element. One or more downstream optical elements image the output of the reflective tunnel directly to the target area (e.g., the object imaged on to the target area is located on an image plane embedded between the reflective tunnel and the front optical element).

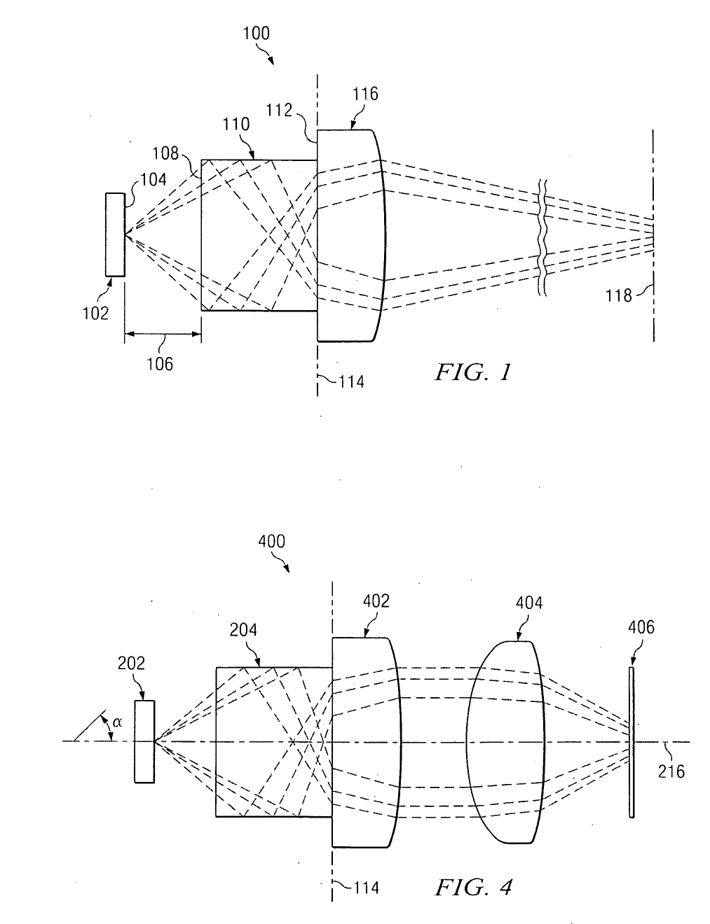

FIG. 1 illustrates a block diagram of a first embodiment of an illumination module 100 as provided herein. It will be appreciated that although the subject matter of FIG. 1 has been described in language specific to structural features, that the subject matter defined in the appended claims is not necessarily limited to the specific features described below. Rather, FIG. 1 illustrates a general concept of the present invention.

Referring to FIG. 1, the illumination module 100 comprises a radiative energy source 102 which outputs divergent radiative energy to a reflective tunnel 110. The radiative energy source 102 has an emitting surface 104 which faces a proximal surface 108 of the reflective tunnel 110 that is separated from the radiative energy source 102 by a small gap 106 (e.g., an air gap, a gap filled with an optically transmissive material that is a poor thermal conductor, etc.). The divergent radiative energy from the radiative energy source 102 is mixed in the reflective tunnel 110, resulting in a substantially uniform radiative energy being output from the distal surface 112 of the reflective tunnel 110 (e.g., the output radative energy is more uniform than the received energy). The output radiative energy forms an image on a first image plane 114. The image formed on the first image plane 114 is imaged directly onto a second image plane 118 by way of a front optical element 116 (e.g., a collimator). In alternative embodiments additional optical elements (e.g., condenser lenses, TIR prisms, etc.) may be placed between the front optical element 116 and the second image plane 118.

It will be appreciated the term reflective tunnel, as used in relation to FIG. 1, encompasses total internal reflection tunnels (TIR tunnels) as well as alternative optical elements having a reflective coating (e.g., plastic optical element with reflective coating). In one embodiment, an optical system is employed utilizing plastic optical elements with a reflective coating less sensitive to external conditions such as humidity than an optical system requiring total internal reflection (e.g., comprising a total internal reflection tunnel).

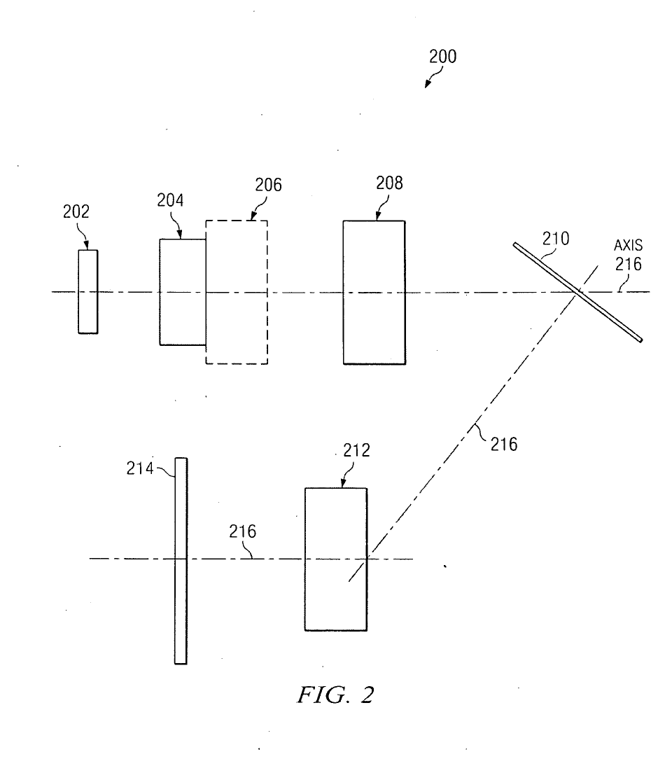

FIG. 2 illustrates a block diagram showing a more specific embodiment of the present invention wherein the illumination module is configured to image a non-uniform radiative energy source (illumination source) onto a spatial light modulator (SLM) with good illumination uniformity and substantially no minimum brightness degradation. The block diagram comprises a light engine 200 configured to directly image an illumination source 202 onto a SLM 210 (e.g., DMD) having a matching aspect ratio.

The light engine 200 comprises an illumination source 202 configured to provide a divergent (e.g., non-uniform) illumination (e.g., visible light) to a total internal reflection tunnel (TIR tunnel) 204 that is optically in contact (e.g., physically cemented) with a front optical element 206 (e.g., collimator lens). The TIR tunnel 204 receives the divergent illumination at its proximal surface (e.g., surface situated closest to the illumination source), mixes the received illumination, and outputs a substantially uniform illumination through its distal surface (e.g., surface situated furthest from the illumination source) to the front optical element 206. The front optical element 206 relays the uniform illumination to one or more downstream optical elements 208 (e.g., a field lens, TIR prism) configured to image the output of the TIR tunnel directly a focal point located at the SLM 210 (i.e., the object imaged on to the DMD is located on an image plane embedded between the TIR tunnel 204 and the front optical element 206).

The TIR tunnel 204, the front optical element 206, and the one or more downstream optical elements 208 comprise an optical system that provides an Abbe configuration, the illumination of the uniform illumination output by the TIR tunnel 204 directly onto the SLM 210. The SLM 210 selectively reflects the received illumination to projection optics 212 located downstream that provide an image to a projection screen 214.

In one embodiment, the optical elements (e.g., 206, 208, etc.) of the light engine 200 are configured to have their center of curvature substantially aligned with the optical axis 216 of the light engine. However, it will be appreciated that although the optical elements (e.g., 206, 208, etc.) of the light engine shown in FIG. 2 are illustrated as being on axis for the illumination side, that this is not a requirement of the present invention. Furthermore, in some embodiments the SLM 210 may be tilted at alternative angles and such alternatives are contemplated as falling within the scope of the invention.

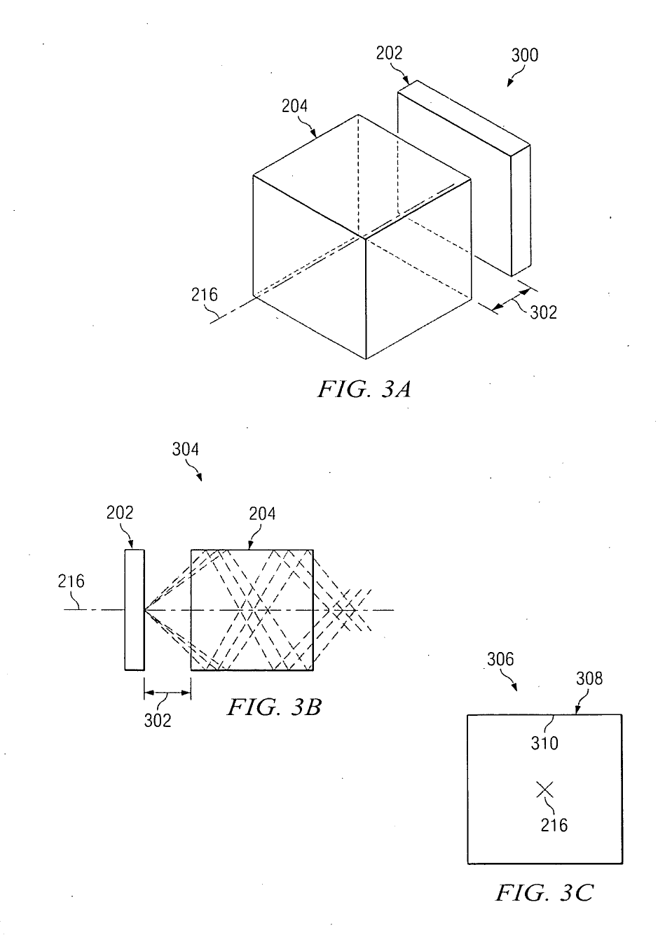

The illumination source and TIR tunnel are illustrated in more detail in FIGS. 3A-3C according to one embodiment. FIG. 3A shows a three dimensional illustration 300 of the illumination source 202 and TIR tunnel 204. FIGS. 3B and 3C respectively show a cross sectional top view 304 and a cross sectional side view 306 of the illumination source 202 and the TIR tunnel 204.

As illustrated in FIGS. 3A-3C, the illumination source 202 is configured such that its emitting surface is separated from the proximal surface of the TIR tunnel 204 by a small gap 302 (e.g., 0.1 mm to 0.5 mm). In one embodiment, the TIR tunnel 204 comprises a shape having opposite parallel faces (e.g., see FIG. 3C) which provide a highly symmetric tunnel shape (e.g., square, rectangle, parallelogram, etc.) that is easily manufactured. In FIGS. 3A-3C, the entrance face of the TIR tunnel is a flat surface parallel to the emitting surface. In an alternative embodiment, the entrance face of the TIR tunnel comprises a concave surface (also on the other side) having a radius of curvature that depends on the tunnel's index of refraction. In general, in one embodiment the TIR tunnel comprises an entrance face having a cross section that is substantially the same as the illumination source (e.g., circular (rod), trapezoidal, etc.).

In one embodiment, the proximal surface of the TIR tunnel 204 is configured to have the same aspect ratio as the illumination source 202, thereby improving coupling between the illumination source 202 and TIR tunnel 204. For example, an illumination source 202 having an emitting aspect ratio of 9×16 will be matched to a TIR tunnel 204 having a proximal surface with a substantially equal aspect ratio.

In another embodiment, the DMD has a different aspect ratio than the TIR tunnel or the illumination source. In such an embodiment, one or more optical elements having an anamorphic power (e.g., one or more cylindrical lens or anamorphic prism) are used in the optical relay (e.g., downstream from the TIR tunnel) to provide an image to the DMD having a proper aspect ratio. For example, one or more cylindrical lenses can be used to image an illumination source having a first aspect ratio (e.g., a square aspect ratio) onto a DMD having a second aspect ratio (e.g., a rectangular aspect ratio; the first aspect ratio stretched in the vertical direction), wherein the first and second aspect ratios are not equal.

The TIR tunnel 204 is comprised of an optical material that allows transmission of visible light. For example, the TIR tunnel 204 may be made of acrylic, polycarbonate or another suitable material, the internal surfaces of which operate as simple reflectors for the light emanating from the emitting surface of the LED at angles that are sufficiently large to result in internal reflection (e.g., total internal reflection) of such light within the tunnel. It will be appreciated that light collection efficiency will be improved by forming the TIR tunnel 204 of materials with higher refractive indexes or by providing highly polished internal surfaces so long as the index of refraction difference between the TIR tunnel 204 and front lens is greater than 0.2 (e.g., preferably 0.3 or 0.5 and higher).

Furthermore, if the TIR tunnel 204 offers a high acceptance angle for TIR propagation, then in embodiments where the illumination source provides a highly divergent illumination the length of the TIR tunnel 204 can be kept small (e.g., 0.3 mm) while still providing a high degree of mixing as will be explained below.

Furthermore, in one embodiment the short TIR tunnel acts as a low pass spatial filter, which “erases” high frequency details or defects of the source such as dark spots and wire shadows without having to reduce the low frequency details. This property offers an advantage that the illumination source could be composed of sub illumination sources in an array that would be modulated depending on the spatial color content of the image to be generated by the DMD to be imaged on the screen.

The configuration of the illumination module in FIGS. 2, 3A-3C provides a number of operational advantages over conventional systems. Separating the TIR tunnel 204 from the illumination source 202 by a small gap 302 increases a reliability of the illumination module by reducing thermal stress on the optical elements (e.g., TIR tunnel, front optical element). For example, often optical elements are formed from plastic (e.g., molded acrylic) material that undergoes changes with increased temperature that change optical properties. Separating the optical elements from the heat produced by the illumination reduces degradation due to thermal stress.

Furthermore, coupling of the TIR tunnel 204 with the front optical element 206 (e.g., lens) improves efficiency of the illumination module by effectively forming a single optical element (e.g., lens) having two different indices of refraction. This configuration allows the position of the TIR tunnel 204 to vary with respect to the front optical element 206 (i.e., precise positioning of the TIR tunnel with the front lens or LED is not required since the tunnel is part of the lens) without reducing the system efficiency, so long as the TIR tunnel 204 remains in contact with the front optical element 206. Therefore, a robust optical system is provided that can accept misalignment in the process without negative effects on performance of the illumination module.

FIG. 4 illustrates a ray diagram of a more detailed embodiment of a light engine 400 comprising an illumination module according to the present invention. The optical train of the light engine 400 comprises an LED 202, a TIR tunnel 204, a front lens 402, a rear optical element 404 (e.g., an aspheric rear lens, a group of lenses, a mirror, etc.), and a DMD 406. In one particular embodiment, the optical elements of the light engine 400 are configured along the optical axis 216.

Illumination (illustrated by the light ray) is output from the LED 202 and is received by the TIR tunnel 204. As illustrated in FIG. 4, the TIR tunnel 204 comprises an index of refraction approximately 0.5 lower than that of the front lens 402, thereby focusing the received illumination (i.e., the light ray) while relaying it to the DMD 406. Illumination enters the TIR tunnel 204 and as it propagates through the TIR tunnel 204 it mixes thereby becoming more uniform. More particularly, illumination from the LED 202 is mixed in the straight short length TIR tunnel 204 by repeated reflection of illumination off the interior walls of the TIR tunnel over the course of the tunnel's length thereby resulting in a substantially uniform illumination. The light traverses from the TIR tunnel 204 and a substantially uniform illumination is output from the TIR tunnel 204 and forms an object onto an image plane 114 embedded between the TIR tunnel 204 and the front lens 402.

The front lens 402 relays the substantially uniform illumination to the rear optical element 404 which is configured to image the object from the image plane 114 directly onto the DMD 406 (i.e., the new object which is imaged onto the DMD is embedded between the end of the TIR tunnel and the front lens).

As shown in FIG. 4, the front lens 402 is configured to optically be in contact with the TIR tunnel 204. In one embodiment, the front lens 402 is physically abutting the TIR tunnel 204. In an alternative embodiment, the front lens 402 is coupled to the TIR tunnel 204 by way of an optically transmissive material that aids in adhesion between the elements. Optical contact between the TIR tunnel 204 and the front lens 402 improve mixing efficiency of illumination received from the LED 202. In one particular embodiment of the light engine 400 shown in FIG. 4, the TIR tunnel 204 is affixed (e.g., cemented) to the front lens 402. Affixing the TIR tunnel 204 on the front lens 402 eliminates any need to hold the TIR tunnel 204 with fixtures that frustrate total internal reflection where the fixture physically touches the TIR tunnel 204.

In another embodiment, the LED 202 (i.e., the illumination source) is highly divergent. In such an embodiment the light output from the LED will enter into the TIR tunnel 204 at an angle, a, relative to the optical axis 216. An increase in the divergence will result in faster mixing of the light (i.e., the relative mixing efficiency is proportional to n and the tunnel length is proportional to 1/n, where maximum efficiency of 1 is for a mirrored hollow tunnel). Therefore, a highly divergent source (e.g., a source having light incident upon the TIR at an angle α>60°) will provide increased mixing of the output illumination from the TIR tunnel 204 relative to an illumination source with lower divergence (e.g., a source providing light incident upon the TIR at an angle α=20°). The increased mixing of illumination from a highly divergent source will improve the uniformity of the light output from the TIR tunnel 204 resulting in a more uniform illumination being relayed to the DMD 406 and projection screen. Furthermore, the use of a highly divergent illumination source allows for a high degree of mixing over a short TIR tunnel distance (e.g., by a TIR tunnel having a length of 0.3 mm).

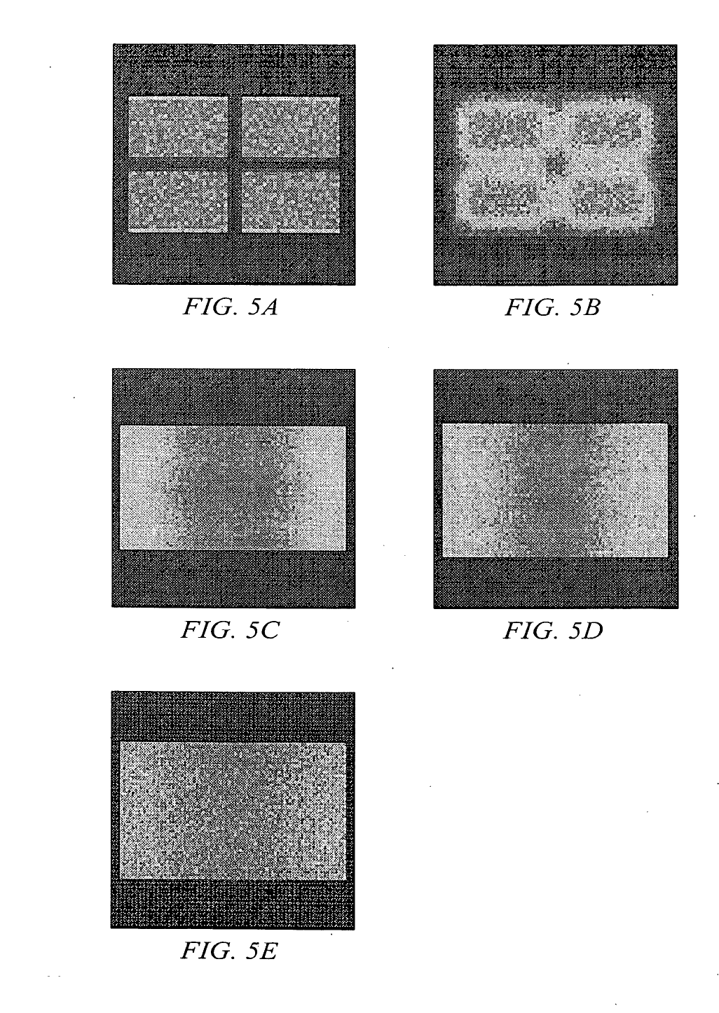

FIGS. 5A-5E illustrates the effect that an illumination source's divergence has on the output of a TIR tunnel for a variety of angles, α, from 0° to 90°. FIGS. 5A-5E illustrate the illumination seen at the exit of a TIR tunnel for different divergences (e.g., FIG. 5A illustrates illumination with 0° divergence, FIG. 5B illustrates 20° divergence, FIG. 5C illustrates 45° divergence, FIG. 5D illustrates 60° divergence, FIG. 5E illustrates 90° divergence). As can be seen, the larger the divergence angle of illumination emitted from the LED the more uniform the illumination output from the TIR tunnel. For example, FIG. 5A shows that illumination entering a TIR tunnel at α=0° (e.g., collimated illumination) will be output from the TIR tunnel at α=0° (e.g., collimated illumination) since there is no mixing through reflection off of the TIR tunnel walls. However, illumination entering the TIR tunnel at an angle of α=90° (Lambertian) will be output from the TIR tunnel as a uniform illumination. Therefore, the illumination module provided herein will ideally comprise an LED configured to provide Lambertian illumination, in one embodiment. However, it will be appreciated that the light source module may also comprise illumination sources (e.g., LEDs) with lesser divergence and still provide a high degree of homogenization over a short TIR tunnel length.

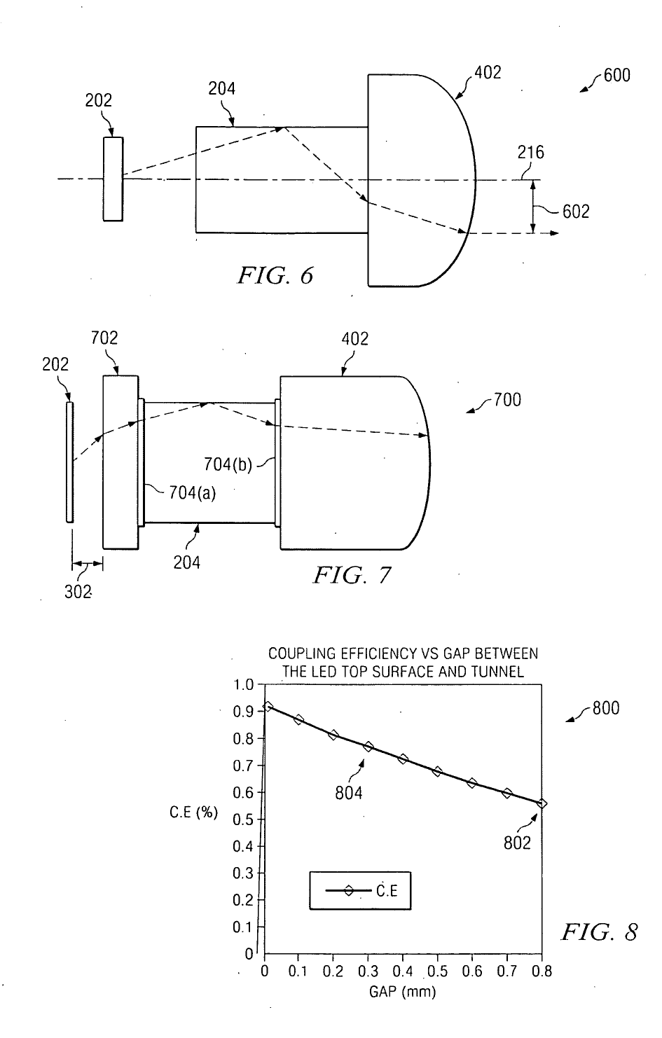

FIG. 6 shows a ray diagram illustrating the effect of having a TIR tunnel 204 and a front lens 402 (e.g., piano-convex lens) configured to have different indices of refraction. In one embodiment, the TIR tunnel 204 is comprised of a material having a refractive index of n≈1.5 (e.g., BK7) and the front lens 402 is comprised of a material having a refractive index of n≈2 (e.g., flint glass, PBH53, PBH75, etc.). As shown in FIG. 6, the resultant difference in refractive index of approximately 0.5 effectively “bends” the light according to Snell's law (i.e., sin Θ₁*n₁=sin Θ₂*n₂, where Θ₁=angle of incidence and n₁=index of refraction), resulting in an input ray being output from the front lens 402 at a distance 602 from the optical axis 216. The larger the refractive index difference between the TIR tunnel and the front lens the greater the ability of the front lens 402 to bend illumination towards the optical axis 216. For example, as shown in FIG. 6, choosing a TIR tunnel 204 to have a smaller index of refraction than the front lens 402 will cause light to be bent towards the optical axis 216 therefore resulting in a front lens 402 which focuses light to upstream optical elements. Bending light, as performed by the front lens 402, further has the effect of reducing the divergence of illumination after it has been mixed by the TIR tunnel 204.

In alternative embodiments, the index of refraction break between the front lens 402 and the TIR tunnel 204 may vary. For example, the front lens may be comprised of materials having an index of refraction greater than 2 or slightly less than 2. Accordingly the resultant difference in refractive index between the front optical element and the TIR tunnel can vary slightly (e.g., Δn=0.4, 0.5, 0.6, 0.7, etc.). However, it will be appreciated that the resultant difference in index of refraction values between the TIR tunnel and the front lens should remain large enough so that illumination divergence is reduced and an image is provided to the DMD. If a large enough index of refraction difference is not provided, illumination from the LED will be highly divergent and it will be difficult to get light onto the DMD with the desired uniformity and smooth illumination profile.

FIG. 7 illustrates a more detailed example of an illumination module 700 as provided herein. The illumination module 700 comprises an illumination source 202 that may comprise an LED light source, for example. The LED 202 will output illumination at a fixed wavelength associated with the band gap of that particular LED. Alternatively, organic light emitting diodes (OLED), vertical cavity surface emitting lasers (VC-SEL) or other suitable light emitting devices may be used as an illumination source. As previously stated, an illumination source having a high divergence is preferable for optimal uniformity in projected illumination.

The illumination source 202 is separated from a front window 702 by a gap 302. The size of the gap 302 is important to the operation of the illumination module 700 as the larger the size of the gap 302 the less light collected by the TIR tunnel 204. FIG. 8 illustrates a graph showing the coupling efficiency of an LED illumination source and the TIR tunnel vs. the gap size. The y-axis of the graph is the coupling efficiency (C.E.) and the x axis of the graph is the gap size measured in millimeters. As illustrated in FIG. 8, the size of the gap 302 (i.e., the distance between the illumination source 202 and the front window 702) is inversely proportional to the coupling efficiency (e.g., the ratio of the power received by the front window divided by the power output from the illuminations source) of the illumination module. For example, at a gap of 0.8 mm (element 802) the coupling efficiency is approximately 57%, while at a gap of 0.3 mm (element 804) the coupling efficiency is approximately 78%. Therefore, it is preferable to minimize the gap between the illumination source 202 and the front window 604 to ensure a high efficiency light engine.

In one embodiment the gap 302 has a size that can be minimized by providing an LED 202 (i.e., illumination source) that utilizes a flip chip structure. An LED utilizing flip chip structure will not have connections on the emitting surface of the LED (e.g., the surface facing the proximal surface of the front window 702) but instead will have connections on the back side of the LED. This removes wire bonding on the side of the LED facing the front window, thereby allowing the LED to get very close to the front window and thereby increasing the coupling efficiency of the illumination module.

Referring to FIG. 7, the primary purpose of the front window 702 is provided to protect from the outside world and to keep the air surrounding the LED free of contaminant of humidity. In one embodiment the front window 702 is coupled to the proximal surface of the TIR tunnel 204 using an optical image matching gel 704 (i.e., 704(a) and 704(b)). The optical image matching gel 704 has an index of refraction that closely approximates that of a TIR tunnel 204 therefore minimizing loss at the interface and reducing Fresnel reflection at the surface of the TIR tunnel 204 and improving the efficiency of the illumination module 700. In one particular embodiment, a commercially available gel having a refractive index of around 1.45 to 1.55 can be used to match both the refractive index of the TIR tunnel 204 and the front window 702). Furthermore, the TIR tunnel and lenses could be also coated to provide lower sensitivity of TIR efficiency to environmental conditions (e.g., humidity, dust), therefore improving reflection even further. Similarly, the distal surface of the TIR tunnel 204 is coupled to the front lens 402 using an optical image matching gel 704. The refractive index of the optical image matching gel 704 should be selected depending on the refractive index of the material of the TIR tunnel 204. In an ideal embodiment the optical matching gel has a refractive index that is equal to sqrt(n₁*n₂), where n₁ is the TIR tunnel index and n₂ is the front lens refractive index, (e.g., n₁˜1.5, n₂=2, resulting in a matching gel having a refractive index of ˜1.73; the gel index value is somewhere between both index surrounding it). In such an embodiment the cumulated reflection at the interface of the TIR tunnel and front lens is <1%. If the refractive index of the optical image matching gel 704(a) is much lower than the refractive index of the TIR tunnel material, a significant portion of emitted light may be lost due to reflections at their interface. Thus, preferably, the refractive index of the optical image matching gel 606 substantially matches or is slightly lower than the refractive index of the TIR tunnel material, in order to facilitate more efficient light collection at the interface with optical matching gel 704(a)

In one embodiment, the TIR tunnel 204 comprises a shape having parallel faces which provide a highly symmetric TIR tunnel shape (e.g., a simple plate having polished edges to increase internal reflection along the TIR tunnel). It can be formed using a BK7 material (e.g., a crown glass produced from alkali-lime silicates comprising approximately 10% potassium oxide and having a low refractive index (≈1.52) and low dispersion (with Abbe numbers around 60)). In alternative embodiments other equivalent materials may also be used to form the TIR tunnel 204. In one example the TIR tunnel may comprise a length of approximately 0.3 mm, for example. In alternative embodiments the TIR tunnel comprises a length of approximately 1.0-2.0 mm, thereby avoiding edge effects on TIR propagation.

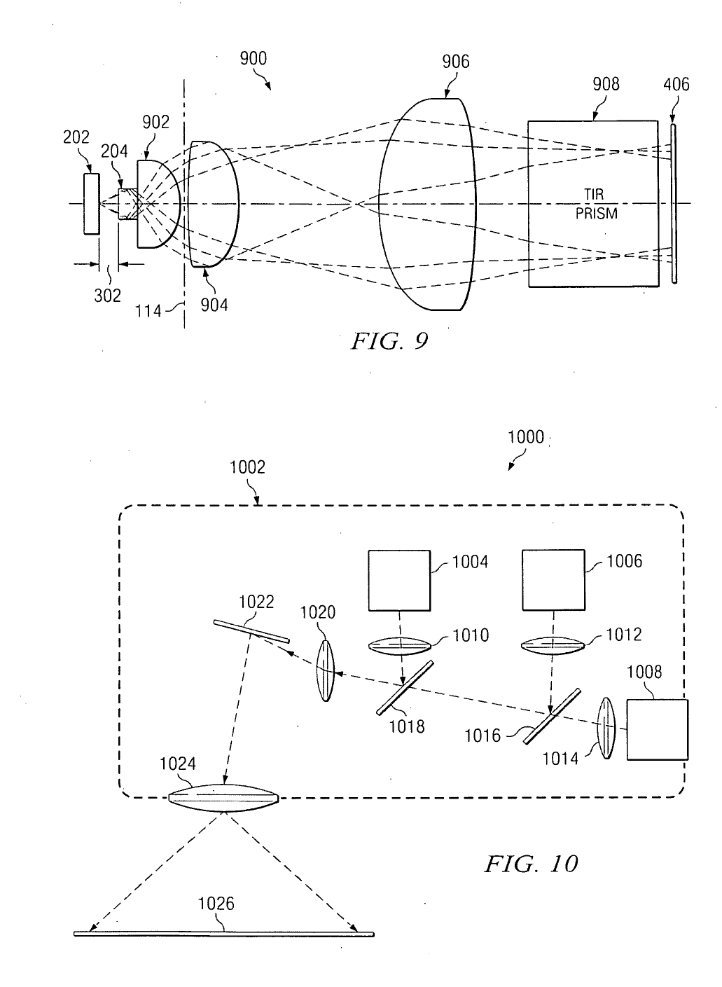

FIG. 9 illustrates an exemplary embodiment of a light engine 900 that utilizes Abbe critical illumination to directly image the illumination module provided herein onto an associated DMD 406. The light engine 900 comprises an illumination module having a TIR tunnel 204 separated from the LED 202 by a small gap 302 (e.g., 0.3 mm). The TIR tunnel 204 is configured to receive illumination from the LED 202 and output a uniform object (e.g., an image) onto an image plane 216 embedded between the TIR tunnel 204 and a piano-convex lens 902. The planar surface of the piano-convex lens 902 abuts the TIR tunnel 204, such that the illumination output from the TIR tunnel 204 is incident upon the planar surface of the piano-convex lens 902.

The piano-convex lens 902 provides illumination to an additional lens 904 configured to reduce divergence of the LED illumination by focusing illumination to a rear lens 906. In one embodiment the rear lens 906 has an aspheric prescription. In alternative embodiments, the rear lens 906 may be comprise a group of lenses configured to project the received image onto the image plane of the DMD or an aspheric condenser lens configured to provide a telecentric beam with a low level of aberration that prevents etendue degradation

In one embodiment, a TIR prism 908 is configured between the rear lens 906 (e.g., aspheric rear lens) and the DMD 406. The TIR prism 908 receives illumination from the rear lens 906 and conveys it to the DMD 406. Placement of the TIR prism 908 requires that the rear lens 906 have a sufficiently large back focal length (BFL) such that the light path can extend to the DMD 406 with the TIR prism 908 in place (e.g., twice the diagonal of a DMD being projected onto). In one embodiment, the TIR prism is replaced by an airgap. In alternative embodiments, the TIR prism is replaced by one of a Polarization Beam splitter, an Xprism, or any other optical elements with substantial glass thickness.

In one embodiment of the light engine 900, the piano-convex lens 902 is comprised of glass and the additional lens 904 and the rear lens 906 comprise aspheric plastic lens (e.g., molded acrylic). The piano-convex glass lens 902 filters the UV spectrum of Blue LED light, thereby avoiding darkening on that channel. The aspheric plastic lenses (904, 906) provide a light weight aspheric surface that is low cost and weight with easier aberration correction than glass spherical lenses.

In one particular embodiment, the light engine of FIG. 9 can be configured to have a light module as shown in FIG. 7 (e.g., FIG. 9 elements 202,104, and 902 are replaced by FIG. 7). In such an embodiment an LED is configured to provide illumination for the light engine. Particularly, the LED comprises a thickness of 0.3 mm and has an emitting surface with a height of 3.8 mm and a width of 2.0 mm. A front window (e.g., 702) comprised of BK7 glass is configured to receive the illumination from the LED. The front window has a thickness of 0.3 mm and is affixed (e.g., cemented) to a TIR tunnel with an optical index matching gel (e.g., 704) having an index of refraction of 1.5. The TIR tunnel (e.g., 104) has a length of 2 mm, a height of 3.9 mm, and a width of 2.2 mm. The TIR tunnel is coupled to a piano convex lens (e.g., 902) by an optical matching gel (e.g., 704) having a refractive index of 1.7. The piano-convex lens is comprised of LAH79 glass and has a planar surface having a thickness of 11.394 mm. The convex surface of the piano-convex lens has a -8 mm radius of curvature and a thickness of 0.386 mm. An additional lens is configured to receive illumination from the piano-convex lens. The additional lens (e.g., 904) is formed of acrylic and has a first conic surface (proximal to the piano-convex lens) having a radius of curvature of 61.06 mm, a conic constant of −99, and a thickness of 9 mm. The additional lens (e.g., 904) also has a second conic surface (distal to the piano-convex lens) having a radius of curvature of −16.41 mm and a conic constant of −0.238. Illumination is relayed from the additional lens to a rear lens located at a distance of 39.2 mm from the previous surface. The rear lens (e.g., 906) is formed from polystyrene and has a first conic surface (proximal to the additional lens) having a radius of curvature of 25.56 mm, a conic constant of −1.24, and a thickness of 13.465 mm. The rear lens also has a second conic surface (distal to the additional lens) having a −54.16 mm radius of curvature, a conic constant −6.474, and a thickness of 5.5 mm. A TIR prism is configured to receive illumination from the rear lens and relay the illumination to the DMD. The TIR prism (e.g., 908) is formed from BK7 glass and has a thickness of 30 mm. Such an exemplary configuration provides a compact light engine with high picture quality (e.g., uniform illumination over the projected image).

It will be appreciated that the system of optical elements included in the light engine 900 of FIG. 9 may include other components in addition to or in place of the condenser, as may be useful for a particular application, for example it may include dichroic mirrors for separating or combining light beams of different colors, or other separators or combiners.

The light engine 900 provides improved performance over traditional light engine optical systems. For example, the performance of an optical system, such as illumination optics of a projection system, may be characterized by a number of parameters, one of them being etendue. The etendue, ε, is a function of the area of the receiver or emitter and the solid angle of emission or acceptance (i.e., Etendue(θ, A)=π*A*sin²(θ), where θ is the maximum source divergence angle A is the area).

If the etendue of a certain element of an optical system is more than the etendue of an upstream optical element, the mismatch may result in loss of light, which reduces the efficiency of the optical system. Therefore, performance of an optical system is usually limited by an optical element in the system that has the smallest etendue. For example, in the projector optical system if the etendue of the illumination source is more than the etendue of the DMD, the performance of the system will be limited by the etendue of the DMD. Therefore, it is important for the source to match the DMD etendue and that the optical system of FIG. 9 provides a good conservation of etendue therefore providing a highly efficient light engine.

FIG. 10 illustrates a block diagram of a projector and light engine comprising a plurality of illumination sources. A plurality of illumination sources (1004, 1006, 1008) output illumination having different wavelengths corresponding to different visible colors. For example, illumination source 1004 comprises an LED that outputs light having a wavelength of approximately 650 nm (e.g., red light), illumination source 1006 comprises an LED that outputs light having a wavelength of approximately 510 nm (e.g., green light), and illumination source 1008 comprises an LED that outputs light having a wavelength of approximately 475 nm (e.g., blue light). Light output from the LEDs (1004, 1006, 1008) travels through an optical train comprising a respective front lens (1010, 1012, 1014), dichroic plates (1016, 1018), a rear group of lenses 1020, and a DMD 1022. As shown in FIG. 10, dichroic plates (1016, 1018) are positioned to reflect light from an associated LED (e.g., dichroic plate 1018 will reflect light from LED 1004) while allowing light from other LED's to pass through the dichroic plate (e.g., dichroic plate 1018 will allow light from LEDs 1006 and 1008 to pass).

The rear group of lenses 1020 will convey light from the LEDs (1004, 1006, 1008) to the DMD 1022. Often the front lens (1010, 1012, 1014), dichroic plates (1016, 1018), a rear group of lenses 1020 are comprised within a lens barrel. The DMD 1022 uses an array of microscopic mirrors that build an image by rapidly switching the DMD “on” and “off” in response to the image data received by the graphics driver. The DMD comprises mirror elements that are fabricated over a semiconductor substrate, which has a memory cell associated with each mirror element. The mirrors of the mirror elements of the DMD operate such that they are in either an on or an off position for each image. Rotation of the mirrors is accomplished with electrostatic attraction produced by voltage differences developed between the mirror and the underlying memory cell. For example, one mirror position may be tilted at an angle of +10 degrees while the other mirror position is tilted at an angle of −10 degrees. The light incident of the face of each mirror complies with optical geometry so as to direct the light from the one mirrors to a projection lens, such as the lens of FIG. 1.

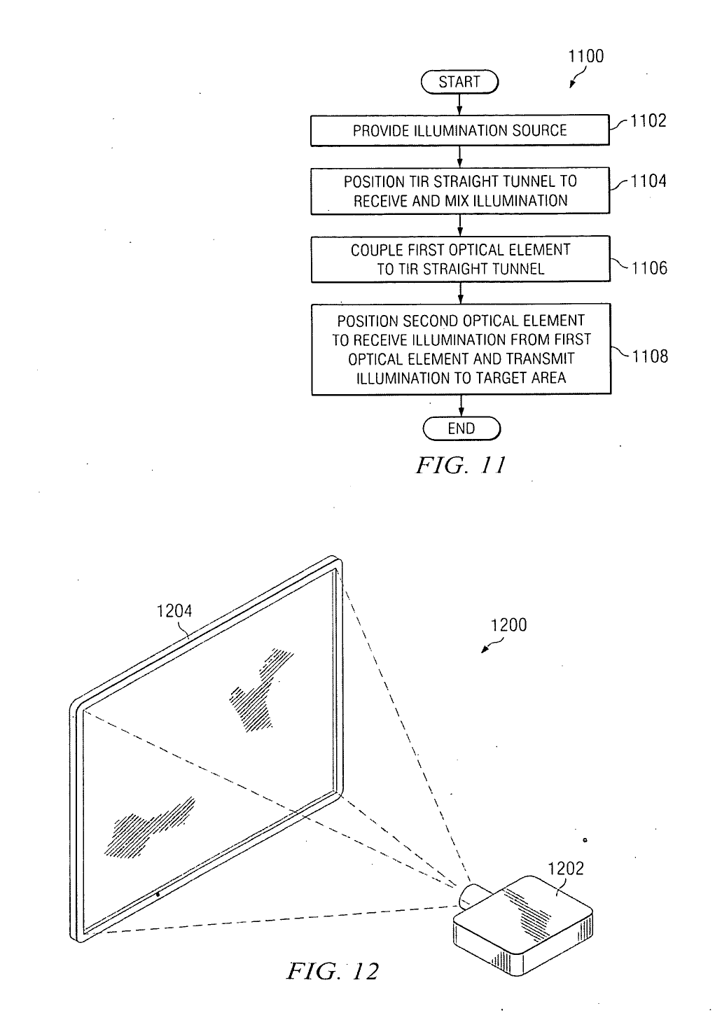

FIG. 11 shows one embodiment of the present invention, a method 1100 for generating an optical system that uniformly images an illumination source onto a spatial light modulator. While method 1100 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the disclosure herein. Also, one or more of the acts depicted herein may be carried out in one or more separate acts and/or phases.

At 1102 an illumination source is provided. The illumination source is specifically configured in one embodiment to provide a high degree of etendue matching between the illumination source and a DMD comprised within the light engine. In alternative embodiments the illumination source also provides illumination having a high degree of divergence.

A TIR tunnel is positioned to receive non-uniform illumination from the illumination source at 1104. The TIR tunnel mixes the non-uniform illumination over the course of transmission along the length of the tunnel resulting in an output illumination having a smooth, substantially uniform illumination profile.

At 1106 first optical element is physically coupled to the TIR tunnel. The first optical element is coupled downstream from the LED. The first optical element relays uniform illumination from an image plane located at the distal edge of the TIR tunnel to additional optical elements downstream. In one embodiment the first optical element is coupled to the TIR tunnel, having an index of refraction 0.5 lower, using an optical image matching gel with an index of refraction substantially equal to the TIR tunnel, thereby reducing loss between the TIR tunnel and the first optical element.

It will be appreciated that the optical projection illumination module and optical engines provided herein can be utilized in a variety of front projection (e.g., front projection movie projector) applications, rear projection (e.g., rear projection television) applications, or any other application where a target is to be illuminated with radiation in high uniformity conditions. For example, FIG. 12 shows one exemplary embodiment of a front projection application, a wall-mounted projection system 1200 utilizing the exemplary optical engine described above. A wall mounted projector unit 1202, including an optical engine such as described above, can be mounted to a wall or other structure using conventional mounting bolts or the like. The wall mounted projector unit 1202 shown in FIG. 12 is configured to place the optical engine at a distance from the wall or a viewing screen 1204, upon which an image can be viewed. In one embodiment, the viewing screen 1204 can be constructed as a digital whiteboard. Due to the large field of view of the optical engine described herein, projector unit 1202 can provide a large image size at a short throw distance.

Although the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. An illumination module for uniformly imaging an illumination source onto a target area, comprising:
an illumination source having an emitting surface that outputs divergent radiative energy;
a reflective tunnel comprising a proximal surface separated from the illumination source by a gap, wherein the reflective tunnel is configured to receive and mix the divergent radiative energy, thereby outputting a substantially uniform radiative energy from the reflective tunnel at a distal surface thereof; and
a front optical element in optical contact with the distal surface of the reflective tunnel, the front optical element configured to receive the uniform radiative energy from the reflective tunnel and relay it to one or more downstream optical elements which project it onto the target area.

2. The illumination module of claim 1, wherein the reflective tunnel comprises a total internal reflection tunnel (TIR tunnel).

3. The illumination module of claim 2, wherein opposite faces of the TIR tunnel are parallel to one another.

4. The illumination module of claim 3, wherein the TIR tunnel has a smaller index of refraction than the front optical element.

5. The illumination module of claim 4, wherein the front optical element optically contacts the TIR tunnel by affixing the TIR tunnel to the front optical element with an optical matching gel.

6. The illumination module of claim 5, wherein the radiative energy comprises a visible light.

7. The illumination module of claim 6, wherein the proximal surface of the TIR tunnel has an aspect ratio substantially equal to that of the emitting surface and the target area.

8. The illumination module of claim 5, wherein the illumination source is lambertian.

9. The illumination module of claim 6, wherein an object located on an image plane formed between the TIR tunnel and the front optical element is projected directly onto the target area.

10. The illumination module of claim 9, wherein the divergence of the illumination source is directly proportional to a mixing efficiency of the visible light.

11. A light engine for uniformly imaging an illumination source onto a digital micro-mirror device (DMD), comprising:
a highly divergence illumination source having a first aspect ratio configured to output an illumination comprising image data for images;
a TIR tunnel having a proximal surface configured to receive the illumination from the illumination source, wherein the TIR tunnel has one or more surfaces which operate as simple reflectors and which mix received illumination resulting in a uniform illumination;
a front lens affixed to the distal surface of the TIR tunnel with an optical matching gel having an index of refraction substantially equal to that of the TIR tunnel;
a DMD having a second aspect ratio; and
one or more downstream optical elements configured to receive illumination from the front lens and directly image the illumination source directly onto a focal point located on the DMD.

12. The light engine of claim 11, further comprising one or more optical elements having an anamorphic power configured to image the illumination source having a first aspect ratio onto the DMD having the second aspect ratio, wherein the first and second aspect ratios are not equal.

13. The light engine of claim 11, further comprising a front window positioned against the proximal surface of the TIR tunnel, the front window configured to receive illumination from the illumination source, diffuse the received illumination, and provide the diffused illumination to the TIR tunnel.

14. The light engine of claim 11, wherein the TIR tunnel comprises BK7.

15. The light engine of claim 11, wherein the illumination source comprises an LED having a flip chip structure.

16. The light engine of claim 11, wherein the illumination source, the TIR tunnel, the condenser lens, the one or more downstream optical elements, and the DMD are co-axially configured along an optical axis.

17. A method for generating an optical system that uniformly images an illumination source onto a digital micro-mirror device (DMD) comprising:
providing an illumination source to output an illumination comprising image data for images;
positioning a TIR tunnel separated from the illumination source by a small gap, the TIR tunnel configured to receive illumination from the illumination source which and mix the received illumination thereby resulting in a substantially uniform illumination; and
optically coupling a first optical element to the TIR tunnel, the first optical element configured to receive the substantially uniform illumination from the TIR tunnel and direct the substantially uniform illumination to one or more downstream optical elements.

18. The method of claim 17, wherein opposite faces of the TIR tunnel are parallel.

19. The method of claim 18, wherein the TIR tunnel has a smaller index of refraction than the front optical element.

20. The method of claim 19, further comprising positioning a second optical element to receive illumination from the first optical element and focus the received illumination to a focal point located on a digital micro-mirror device (DMD).
